(19) United States
(12) Patent Application Publication
(10) Pub. No.: US 2002/0067265 A1
(43) Pub. Date: Jun. 6, 2002

(54) Intelligent Package For Controlled Product Distribution

(76) Inventor: Richard F. Rudolph, Loveland, OH (US)

Correspondence Address: Gibbons, Del Deo, Dolan,, Griffinger & Vecchione, One Riverfront Plaza, Newark, NJ, 07102, US

(21) Appl. No.: 09/809,740

(22) Filed: Mar. 15, 2001

Related U.S. Application Data
(60) Provisional application No. 60/189,594, filed on Mar. 15, 2000.

(51) Int. Cl. G08B 26/00

(52) U.S. Cl. 340/572.1; 340/568.1; 340/571; 340/10.1

(57) ABSTRACT

### Abstract of Disclosure

An active package system comprising: a package; a first identification tag coupled to the package; a controller that stores identifying data coupled to the first identification tag; and, an interrogator located external to the package, wherein the first identification tag in response to a query from the interrogator communicates the identifying data and the first identification tag is adapted for initiating a query to a second identification tag.

### Cross Reference to Related Applications

This application claims priority from U.S. Provisional Application Serial No.60/189,594 which was filed on March 15, 2000 and is incorporated by reference.

### Background of the Invention

### Field of the Invention

This invention relates to the field of packaging, and more particularly to a package interfacing to a computer system.

### Description of the Related Art

Contents of packages that are susceptible to damage during their movement, storage, shipment and subsequent handling require special handling. Frequently damage is hidden and disputed as to where and when the damage occurred. Monitoring of environmental conditions that packages are exposed to is minimal and only indirect.There is a need to be able to automatically and directly monitor packages that are susceptible to damage during their movement, storage, shipment and subsequent handling.

### Summary of Invention

The present invention is an active package system comprising: a package; a first identification tag coupled to the package; a controller that stores identifying data coupled to the first identification tag; and, an interrogator located external to the package, wherein the first identification tag in response to a query from the interrogator communicates the identifying data and the first identification tag is adapted for initiating a query to a second identification tag.

The present invention also includes a method for monitoring a package. The method comprises the steps of: (i) providing an active package system comprising (a) a first identification tag coupled to the package; (b) a controller that stores identifying data coupled to the first identification tag; and, (c) an interrogator located external to the package; (ii) sending a query signal from the interrogator to the identification tag; and (iii) responding to the query signal by communicating the identifying data from the identification tag to the interrogator.

### Brief Description of Drawings

A more complete understanding of the present invention may be obtained from consideration of the following description in conjunction with the drawings in which:

FIG. 1 is a functional overview of a system employing the present invention; and,

FIG. 2 is a diagrammatic view of an enhanced active package system employing the present invention.

### Detailed Description

The present invention is an active package system. The system is comprised of a package, at least one identification tag, a controller that stores identifying data, and an interrogator. The identification tag responds to a query from the interrogator by communicating the identifying data stored in the controller. The identification tag can also be adapted to initiate a query to a second identification tag. The interrogator may be employed to transfer the query from the identification tag to the second identification tag.

The package may be any material or structure that holds a product or data. For example paper, cardboard, plastic, wood, metal, and the like may be used.

The identifying data carried by the identification tag comprises information such as, product identification, serial number, activation codes for executing a script file, a URL or other reference to a web site, or any similar type of information.

The identifying data is retrieved by an interrogator, which transmits a query to the identification tag. The identification tag responds to the query by communicating the identifying data. Thus the interrogator selected for use in the present invention is capable of communicating with the identification tag. Suitable interrogators include, but are not limited to laser scanners, RFID readers, and the like, depending on the particular identification tag employed.

In one embodiment, bar codes are employed as at least a portion of the identification tag. They are graphical representations of information encoded within a series of bars and spaces. Some bar code symbologies, such as UPC-A, have a specific bar code pattern for each character based upon the location of that character within the bar code. For example, a number 3 in the first part of the bar code is encoded differently than a number 3 in the second half of the bar code. Still other symbologies encode data in pairs and are dependent upon the preceding or following characters as to which pattern is used.

All bar codes have certain bar code patterns which tell the reading device when to start reading the bar code and when to stop reading. PrintBar III automatically adds all Start and Stop characters within the bar code. In some bar code symbologies, an option is provided to either print or not print the Human Readable portion of these characters. Human Readables are the alphabetic and numeric characters for the data encoded within the bar code. When used, Human Readable (HR) characters may be printed below or above the bar code. Check Digits mathematically calculated values which help the reading device determine if the bar code was read correctly. Check digit characters are usually added to the end of the bar code. Some symbologies, such as Code 39, do not need check digit characters as they are designed to be self checking. Other symbologies, such as UPC-A, require check digits be added. Supplements are a separate, shorter bar code that can be optionally added to the end of certain symbologies such as UPC, EAN and JAN to encode prices, dates, etc. When used, Human Readable characters are always printed above the supplement.

2-Dimensional bar codes enable more information to be encoded in a smaller space than a traditional 1-dimensional bar code. Essentially there are two types of 2-dimensional bar codes currently in use: stacked codes; and, matrix codes.

Stacked symbology, evolved from 1-dimensional bar codes, such as Code 39 and Code 128 symbologies, which are stacked in horizontal layers to create a multirow symbologies, Code 49 and Code 16K respectively.

Matrix Symbologies, which are scaleable, provide higher data densities than stacked codes in most cases, as well as are orientation independent. A matrix code is comprised of a pattern of cells which can be square, hexagonal or circular in shape. Data is encoded into the matrix through the relative positions of the light and dark areas. Encoding schemes can utilize error detection and correction techniques for improved reading reliability, including enabling the reading of partially damaged symbols.

Composite bar codes is a class of symbology in which two symbols are printed in close proximity to each other and contain linked data. Typically, one component is a linear bar code symbol and the other component is a multi-row or matrix bar code symbol. The composite bar code enables different information to be available to different applications during an items" life cycle. A typical use of a composite bar code is in the pharmaceutical industry where both product identification and supplementary information, such as expiration date and batch number, are encoded in a small area for access in different applications during the product life cycle. The UCC.EAN composite symbol standard includes EAN-13 or UPC-A or UCC.EAN 128 symbols, as well as the RSS (reduced space symbologies) together with a two-dimensional multirow symbol.

An interrogator for bar codes comprises a bar code scanner, which typically utilizes CCD or laser technology, either hand held or fixed mount, such scanners essentially contain a means for illuminating the bar code symbol and a means for measuring the reflected light. The reflected light data is converted into a digital signal, which can then be decoded. A typical CCD scanner utilizes a flood of light, such as an LED light source, to illuminate the bar code symbol, which is reflected back to an array of photosensors. A laser scanner typically utilizes a laser beam, having a source such as a laser diode, which is spread into a horizontal arc by a rapidly moving mirror. More sophisticated scanning patterns including a moving-beam raster, cross-hatched, or starburst pattern can provide improved readability and omni-directional scanning.

In a preferred embodiment, the identification tag comprises a radio frequency identification (RFID) tag. RFID tags come in a wide variety of shapes and sizes. RFID tags maybe categorized as either active or passive. Active RFID tags may be powered by an internal battery and are typically read/write, i.e., tag data can be rewritten and/or modified. An active tag memory size varies according to application requirements. Some systems operate, for example with up to 1MB of memory. In a typical read/write RFID system, a tag can provide a set of instructions or information, and the tag can receive encoded information. This encoded data then becomes part of the history of the tagged product. The battery-supplied power of an active tag generally gives it a longer read range. The trade off is greater size, greater cost, and a limited operational life.

Passive RFID tags operate without a separate external power source and obtain operating power generated from the reader. Passive tags consequently are usually lighter in weight than active tags, less expensive, and offer a virtually unlimited operational lifetime. The trade off is that passive tags have shorter read ranges than active tags and require a higher-powered reader.

Read-only tags are typically passive and are programmed with a unique set of data (usually 32 to 128 bits) that cannot be modified. Read-only tags may operate as a key or index into a database, in the same way as linear barcodes reference a database containing modifiable product-specific information.

When a RFID tag is used, an antenna is included in the system of the present invention. The antenna receives and transfers radio signals to activate the tag and to read and write data to the tag. Antenna may be a variety of shapes and sizes. For example, an antenna can be built into a doorway to receive tag data from persons or things passing through the door. An electromagnetic field produced by an antenna can be constantly present when multiple tags are expected continually. If constant interrogation is not required, a sensor device can activate the field.

An antenna maybe configured with the transceiver/decoder to become part of the reader or interrogator, which can be configured either as a handheld or a fixed-mount device. The reader emits radio waves across distances of anywhere from one inch to 100 feet or more, depending upon the signal power output and the radio frequency used. When an RFID tag passes through an electromagnetic sensing zone, the tag responds to the activation signal of the reader and causes an associated antenna to emit radio waves. The reader decodes the data encoded in a memory portion of an integrated circuit of the tag. The data is passed to a host computer for processing.

Frequency ranges also distinguish RFID systems. Low-frequency (30 kHz to 500 kHz) systems typically have short reading ranges and lower system costs. They are most commonly used in security access, asset tracking, and identification applications. High-frequency (850 mHz to 950 mHz and 2.4 gHz to 2.5 gHz) systems typically offer long read ranges (greater than 90 feet) and high reading speeds.

A significant advantage of RFID systems is the non-contact, non-line-of-sight nature of the technology. Tags can be read through a variety of substances such as snow, fog, ice, paint, crusted grime, and other visually and environmentally challenging conditions, where barcodes or other optical read technologies are problematic. RFID tags can also be read in challenging circumstances at high speeds, typically responding in less than 100 milliseconds.

The range that can be achieved with an RFID system is determined essentially by: power available at the reader/interrogator to communicate with the tag(s), power associated with the tag to respond, and environmental conditions and structure, the former being more significant at higher frequencies, including signal to noise ratio.

Although the level of available power is a primary determinant of range, the manner and efficiency with which that power is employed also influences the range. The field or wave delivered from an antenna extends into the space adjacent the antenna and its strength diminishes with respect to distance. Antenna design will determine the shape of the field or propagation wave delivered, so that range will also be influenced by the angle subtended between the tag and antenna.

In space free of any obstructions or absorption mechanisms, the strength of a field declines in inverse proportion to the square of the distance between transmitter and receiver. For a wave propagating through a region in which reflections can arise from the ground and from obstacles, the reduction in signal strength can vary quite considerably. In some cases, signal strength may vary as an inverse fourth power of the distance between transmitter and receiver. Where different propagation paths arise, the phenomenon is known as multi-path attenuation. At higher frequencies, absorption due to the presence of moisture can further influence range. It is therefore important in many applications to determine how the environment, internal or external, can influence the range of communication. Where a number of reflective metal "obstacles" are to encountered within the application to be considered, and can vary in number from time to time, it may also be necessary to establish the implications of such changes through an appropriate environmental evaluation.

A computer system is associated with the active package system of the present invention. The computer system can be coupled to the interrogator and can interpret the communication from the identification tag. The active package system preferably also includes one or more sensors. The computer system interfaces with the sensors to record measurements and data gathered by the sensors. Moreover, the computer system may be configured to process the identifying data and execute a command or series of commands based upon the data.

Each sensor is coupled to the package and senses a variable or variables inside and/or outside the package. For example, the sensor may sense weight, contents, temperature, humidity, duration at a location, arrival and departure times, impact damage, remaining quantity, pressure, and combinations thereof.

The present invention also contemplates a method for monitoring a package. The method comprises the steps of: (i) providing an active package system comprising(a) a first identification tag coupled to the package; (b) a controller that stores identifying data coupled to the first identification tag; and, (c) an interrogator located external to the package; (ii) sending a query signal from the interrogator to the identification tag; and (iii) responding to the query signal by communicating the identifying data from the identification tag to the interrogator. The method may also include step (iv) initiating a query from the identification tag to a second identification tag. The interrogator may be employed to transfer the query from the identification tag to the second identification tag.

Although the present invention is particularly well suited for monitoring packages in transit, and shall be so described, the present invention is equally well suited for use in controlled product distribution, product storage and various manufacturing and distribution environments.

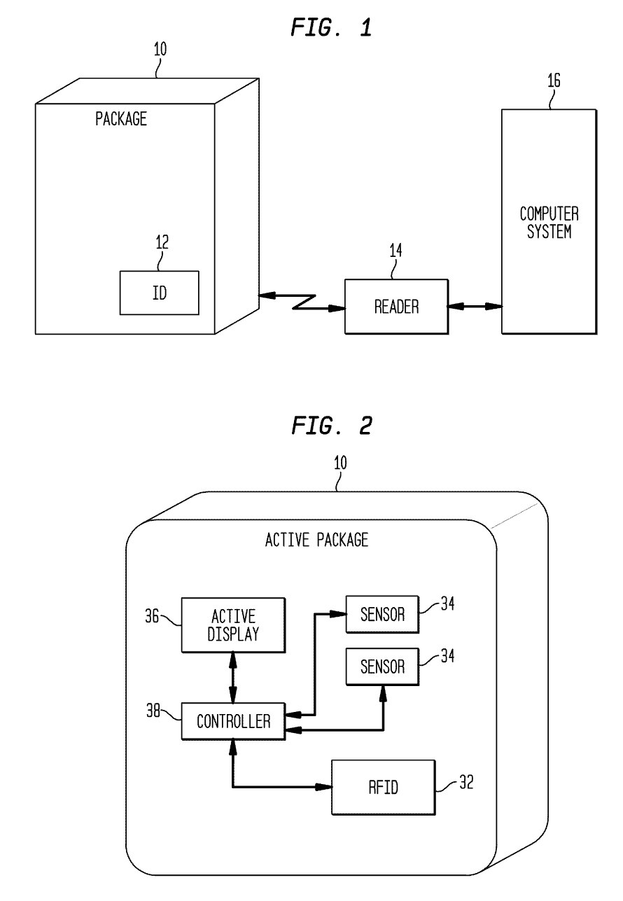

Referring to FIG. 1 there can be seen a functional overview of a system employing the present invention. A package 10 contains an identification tag 12. The identification tag 12 may be an RFID or other suitable identification tag 12. The identification tag 12 contains encoded data corresponding to a unique product identification, serial number, and history of the environmental conditions and location corresponding to the package 10. A reader 14 interrogates the identification tag 12. The interrogator 14 is coupled to a computer system 16.

Referring to FIG. 2 there can be seen a detailed functional overview of an active package system employing the present invention. The active package can provide information concerning contents, location, history, and handling. Information can include package weight, contents, internal temperature, humidity, and duration at various locations while in transit, arrival and departure times, impact damage, and remaining quantity. The active package 10 contains an RFID 32, sensors 34 and an active display 36. Sensors 34 may include internal and external temperature, impact (acceleration), pressure, humidity, tamper, weight, and quantity. A controller 38, such as a single chip computer, is coupled to the sensors 34, active display 36 and RFID 32. The controller 38 processes data from the RFID 32 and the sensors 34. In response to a predetermined query by a reader/interrogator system (not shown in FIG. 2) the RFID transmits the data that the controller 38 has accumulated and processed. Smart articles within the package 30 could also communicate with the RFID 32, updating their status and integrity, providing an early warning system for concealed damage. The status would include date, time and location stamping, thus allowing the source of damage to be pin pointed. Pressure transducers can detect loose or shifting articles as well as repetitive vibrations, corresponding to potential and/or actual damage and breakage.

Pressure sensors, such as pressure sensitive film in the package walls including the top and bottom, provide data on the pressure applied to each pixel area, thus enabling a composite force to be determined and integrated. This will provide information on the weight of the package and the contents, forces applied to the sidewalls, and forces on top of the box (stacking).

The controller 38 can be a single chip computer or other system capable of controlling, and accessing the sensors, storing information and relaying the information in response to an external stimulus. The controller 38 is enabled to interrogate the contents of the active package 10 as well as the surrounding environment through the RFID 32. This establishes communication between the contents of the package, which may include other intelligent packages, the surrounding environment (location, etc.) and the active package 10.

Concealed damage can be detected and revealed in a number of ways. A smart article within the package can have sensors, which check the integrity and reliability of each smart article. If deviations at predetermined limits or responses occur, a potential problem is noted and transmitted to the active package for further processing and possible action. Details of various sensors are known to those skilled in the art. Further information on sensors can be found in Process Instruments And Controls Handbook by Douglas Considine published by McGraw-Hill (1974) which is incorporated herein by reference.

The information provided by the active package 10 can be communicated to a remote computer system over the internet, thus enabling a shipper or other concerned party to monitor and tract the actual status and integrity of the active package 10.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the invention.

Claims

1. An active package system comprising:
a package;
a first identification tag coupled to said package;
a controller that stores identifying data coupled to said first identification tag; and,
an interrogator located external to said package,
wherein said first identification tag in response to a query from said interrogator communicates said identifying data and said first identification tag is adapted for initiating a query to a second identification tag.

2. The package system of claim 1, wherein said first identification tag is selected from the group consisting of: a linear bar code, a composite bar code, a 2-dimensional bar code, and a radio frequency identification transponder.

3. The package system of claim 1, wherein said identifying data is selected from the group consisting of: a product identifier, a serial number, a user identifier, a URL or other reference to a web site, and combinations thereof.

4. The package system of claim 1, further comprising a computer system that is coupled to said interrogator.

5. The package system of claim 1, further comprising a sensor coupled to said package.

6. The package system of claim 5, wherein said sensor senses a variable selected from the group consisting of: weight, contents, temperature, humidity, duration at a location, arrival and departure times, impact damage, remaining quantity, pressure, and combinations thereof.

7. The package system of claim 1, further comprising an active display.

8. The package system of claim 1, wherein said interrogator transfers said query to said second identification tag.

9. A method for monitoring a package comprising:
(i) providing an active package system comprising:
a first identification tag coupled to said package;
a controller that stores identifying data coupled to said firstidentification tag; and,
an interrogator located external to said package,
(ii) sending a query signal from the interrogator to the identification tag; and
(iii) responding to the query signal by communicating the identifying data from the identification tag to the interrogator.

10. The method of claim 9, wherein said first identification tag is selected from the group consisting of: a linear bar code, a composite bar code, a 2-dimensional bar code, and a radio frequency identification transponder.

11. The method of claim 9, wherein said identifying data is selected from the group consisting of: a product identifier, a serial number, a user identifier, a URL or other reference to a web site, and combinations thereof.

12. The method of claim 9, wherein said active package system further comprises a computer system that is coupled to said interrogator.

13. The method of claim 9, wherein said active package system further comprises a sensor coupled to said package.

14. The method of claim 13, wherein said sensor senses a variable selected from the group consisting of: weight, contents, temperature, humidity, duration at a location, arrival and departure times, impact damage, remaining quantity, pressure, and combinations thereof.

15. The method of claim 9, wherein said active package system further comprises an active display.

16. The method of claim 9, further comprising step (iv) initiating a query from said identification tag to a second identification tag.

17. The method of claim 16, wherein said interrogator transfers said query from said identification tag to said second identification tag.
